(19) United States
(12) Patent Application Publication
(10) Pub. No.: US 2025/0020511 A1
(43) Pub. Date: Jan. 16, 2025

(54) BROADBAND TIME-RESOLVED THZ SYSTEM

(71) Applicant: OZ Optics Ltd., Ottawa (CA)

(72) Inventors: Jean-Michel Ménard, Ottawa (CA); Nicolas Couture, Nepean (CA)

(21) Appl. No.: 18/220,360

(22) Filed: Jul. 11, 2023

(30) Foreign Application Priority Data
Jul. 11, 2022 (CA) 3164512

(51) Int. Cl. G01J 3/42; G01J 3/50

(52) U.S. Cl. CPC G01J 3/42; G01J 3/50; G01J 3/2889

(57) ABSTRACT

There is provided a system comprising a combination of a peak field booster with elements to increase spectral bandwidth and efficiency for THz generation and detection. The system is configured to achieve a high dynamic range around 3.5 THz while relying on a cost-effective NIR source, allowing the full system to be built at a lower cost and sold at a competitive price.

### TECHNICAL FIELD

The present invention relates to a broadband time-resolved THz system.

### BACKGROUND OF THE INVENTION

The far-infrared region of the electromagnetic spectrum of light corresponding to optical wavelengths between 10 μm and 1000 μm and known as the terahertz (THz) band, is one of the richest areas of research and development. THz radiation has a non-ionizing photon energy offering new opportunities for non-invasive optical characterization of products and materials. Notably, it is used to evaluate drug quality, detect structural flaws, identify organic and non-organic contaminants in foods, and alert on the presence of bacteria and viruses. These applications take advantage of unique properties of THz radiation: It can be transmitted through cardboards, polymers, and other materials opaque in the visible region, and it interacts with a large range of molecular vibrations, thereby enabling the detection and identification of many different compounds.

THz time-domain spectroscopy (THz-TDS) is an emerging characterization technique that relies on the generation and detection of phase-locked THz pulses. This technique can be used to extract both amplitude and phase information of a THz pulse while tracing its full oscillating electric field. This is quite advantageous over any other optical characterization techniques recording only the variations in optical intensity. When the THz pulse is transmitted through a medium or reflected at its surface, THz-TDS can directly extract the refractive index and absorption spectrum of that medium. Because THz technology offers such distinctive specifications, it complements, rather than competes, with other characterization techniques based on CCD cameras, mass spectrometry, and laser-based systems. This is also why THz devices are in increasingly high demand.

Due to the scientific and practical significance, THz technology is a fast-growing field in photonics research and development. Nonetheless, access to a broadband, sensitive, and affordable THz spectrometer is still a major hurdle to many applications in industrial and academic settings. Some major international laser companies and optical component distributors have recently launched commercial THz-TDS systems. However, these systems are usually bulky and costly, with a selling price generally exceeding $100 k and approaching $300 k for some specific specifications. These drawbacks are mainly due to one essential component in the design of these systems: a large and expensive ultrafast near-infrared (NIR) laser source, which must be below 100 fs. Some prior art systems rely on amplified lasers, others rely on an even more costly lasing medium such as Ti:Sapphire, and others rely on two laser sources.

THz time-domain spectroscopy (THz-TDS) is a technique increasingly used in academia and industry for remote non-invasive characterization of materials. For scientific research, it can be used to characterize low-energy resonances and identify chemicals, proteins, gases, etc. It can also be used to resolve optically-induced dynamical phenomena to explore changes happening in the structure, chemistry or electrical properties of a sample. For industrial applications, it can be used for quality control of many products including food, pharmaceuticals, and chemicals entering in the fabrication of other products.

Most THz-TDS systems have a peak sensitivity limited to the window between 0.5 and 3 THz. Standard time-resolved THz systems are either based on photoconductive antenna or nonlinear optical conversion in ZnTe or LiNbO3 crystals for THz generation and/or detection. These two types of systems lead to intrinsic spectral bandwidth limitations.

One of the limitations of technology based on photoconductive antenna is an accessible bandwidth that is limited by carrier transport properties in semiconductors. It is unlikely that research and development in material design and fabrication will be able to push this limit to allow future generation components to efficiently support frequencies higher than 3 THz.

For the technology based on nonlinear crystals, a further limitation stems from the bandwidth often being limited by the material absorption in the THz window. ZnTe and LiNbO₃ are two semiconductors with favorable linear and nonlinear properties to generate or detect THz radiation, but they also have significant phonon absorption at frequencies above 3 THz. Other materials featuring broadband transmission in the THz region are often not as efficient at generating THz radiation because of their linear or nonlinear properties. Although it is possible to increase the propagation length inside a nonlinear material to compensate for its small nonlinear coefficient (effectively related to the ability of the material to induce nonlinear interactions leading to THz generation or detection), this reduces the accessible THz bandwidth due to a process known as phase matching conditions.

Although some THz system manufacturers claim to have a THz-TDS system able to access a spectral bandwidth extending up to 8 THz, it is important to consider that these commercial products also have a relatively small signal-to-noise ratio above 3 THz, making the device less effective or sometimes not effective at all above 3 THz. This value determines the usefulness of the device in performing measurements and is demonstrated by the small volume of scientific work in the literature focusing on the spectral window between 3 and 5 THz.

Another intrinsic problem with current systems is that broadband THz-TDS systems able to access frequencies beyond 3 THz are bulky and expensive. THz-TDS setup rely on an ultrafast NIR laser delivering less than 100 fs pulses to generate and detect broadband THz pulses. These NIR lasers are bulky and expensive, typically costing more than $100 k.

Some examples of current systems are as follows, and incorporated herein by reference:
Couture, Nicolas et al; “Compact, low-cost, and broadband terahertz time-domain spectrometer”, Optica, Applied Optics, volume 62, issue 15, page 4097, 2023
Halpin, Alexi et al; “Enhanced Terahertz Detection Efficiency via Grating-Assisted Noncollinear Electro-Optic Sampling”, American Physical Society, Phys. Rev. Applied, volume 12, issue 3, page 031003, 2019.
Cui, Wei et al, “Broadband and High-Sensitivity Time-Resolved THz System Using Grating-Assisted Tilted-Pulse-Front Phase Matching”, Advanced Optical Materials published by Wiley-VCH GmbH, Volume 10, Issue 1, Jan. 4, 2022.
W. Cui et al, “Broadband and high-sensitivity time-resolved THz system with grating assisted noncollinear phase-matching,” 2020 45^{th} International Conference on Infrared, Millimeter, and Terahertz Waves (IRMMW-THz), pp. 1-2, 2020.
Halpin, A. et al, “Enhanced THz detection efficiency via grating-assisted noncollinear electro-optic sampling,” 2019 44^{th} International Conference on Infrared, Millimeter, and Terahertz Waves (IRMMW-THz), pp. 1-2, 2019.
US Publication No. 202020191710

### SUMMARY

In one aspect of the present invention there is provided a system which combines three modules into a THz-TDS system employing a relatively low-pulse-energy and, therefore, cost-effective laser delivering <100 fs pulses. The first module is a fiber-based module, called a peak-field booster (PFB), placed at the output of the ultrafast laser. In short, this module broadens the spectrum of the laser and compresses the pulse to a shorter time duration (<100 fs), thus enhancing the peak electric field of the original source. The second module is a nonlinear crystal with a phase grating etched on the surface for THz generation. For THz generation, this allows for phase-matching at higher THz frequencies while using thick crystals, resulting in a broadband and (relatively) strong THz pulse. On the detection side, the third module is a similar phase grating etched on the surface of the THz detection crystal allowing for a broader THz detection spectral window, but also increasing the sensitivity of the system.

In one example embodiment, the modules may be combined together to provide optimal performance in terms of THz spectral bandwidth and sensitivity. Relating to spectral bandwidth, removing the peak field booster or the phase grating from the surface of the THz crystals drastically reduces the accessible THz bandwidth to frequencies lower than 3 THz and also reduces the sensitivity as the THz generation would be less efficient and the higher THz frequencies may not be efficiently generated and/or resolved. If the nonlinear crystals are replaced by thinner crystals supporting a larger THz bandwidth, the THz generation and detection processes become less efficient and the system loses sensitivity. Therefore, the three components work together to ensure a system with broad spectral bandwidth and high sensitivity.

It is noted that if gallium phosphide (GaP) is used as the crystal, this crystal only allows for THz generation and detection up to 6 THz due to an intrinsic property of the crystal. Also, it is noted that it is possible the PFB may not be implemented for amplified lasers since high power lasers could burn the fiber.

In one aspect there is provided a THz system comprising, a generator having an optical source followed by a peak-field booster (PFB) unit and a first periodically patterned nonlinear crystal; and a detector having a second periodically patterned nonlinear crystal.

In a further aspect, there is provided a system wherein the optical source is an ultrafast NIR laser.

In yet a further aspect, there is provided a system wherein the first periodically patterned nonlinear crystal is a GaP crystal.

In yet a further aspect, there is provided a system wherein the second periodically patterned nonlinear crystal is a GaP crystal.

In yet a further aspect, there is provided a system wherein the optical source is centered at a wavelength of 1064 nm.

In yet a further aspect, there is provided a system wherein the PFB is a fiber and a pair of chirped mirrors.

In yet a further aspect, there is provided a system wherein the PFB module is replaced by another module relying on a highly nonlinear material for spectral broadening

In yet a further aspect, there is provided a system wherein the PFB module is replaced by another module relying on any dispersion compensation components including a prism pair or a fiber Bragg grating.

In yet a further aspect, there is provided a system further comprising a purge box enclosing the first periodically patterned nonlinear crystal; and the second periodically patterned nonlinear crystal.

In yet a further aspect, there is provided a system wherein the purge box further comprises a Germanium wafer following the first periodically patterned nonlinear crystal.

In yet a further aspect, there is provided a system wherein the detector comprises a delay stage, a quarter-wave plate, a Wollaston prism, and balanced photodetectors.

### BRIEF DESCRIPTION OF THE DRAWINGS

The invention will be further understood from the following description with reference to the attached drawings illustrating example embodiments.

FIG. 1a illustrates an image of a compact time-domain spectrometer.

FIG. 1b illustrates a schematic of a compact time-domain spectrometer.

FIG. 2a illustrates a graph of NIR spectra showing a comparison of an NIR laser with an NIR laser and PFB.

FIG. 2b illustrates a graph of autocorrelation traces showing a comparison of an NIR laser with a NIR laser and PFB.

FIG. 3a illustrates a graph of time domain traces showing a comparison of a laser with crystals with no grating; a laser with an etched crystal for the generator; and a laser with an etched crystal and a PFB for the generator.

FIG. 3b illustrates a graph of spectral intensity showing a comparison of a laser with crystals with no grating; a laser with an etched crystal for the generator; and a laser with an etched crystal and a PFB for the generator.

FIG. 4a illustrates a graph of spectral amplitude for a laser with a PFB and an etched crystal for generation and showing a comparison of an etched thick crystal in the detector and an unetched thin crystal in the detector.

FIG. 4b illustrates a graph of dynamic range for a laser with a PFB and an etched crystal for generation and showing a comparison of an etched thick crystal in the detector and an unetched thin crystal in the detector.

### DESCRIPTION OF THE PREFERRED EMBODIMENTS

A preferred embodiment of the present invention will be set forth in detail with reference to the drawings, in which like reference numerals refer to like elements or method steps throughout.

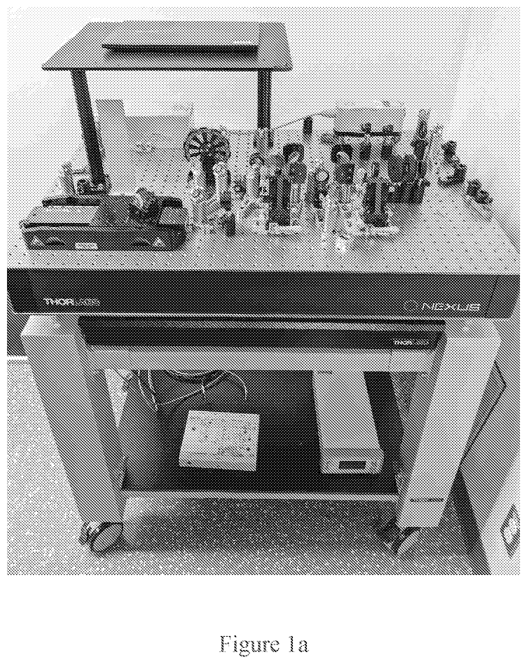

In one aspect of the present invention, there is provided a compact THz-TDS system illustrated in FIG. 1 and having three modules: (a) a fiber-based peak field booster (PFB) 10, (b) a THz generation process relying on a crystal 12 with a phase grating etched on its front surface, and (c) a THz detection process 14 using a similar nonlinear crystal are provided. The crystal may be made of 110-oriented gallium phosphide (GaP). The THz EOS detection process 16 may include electro-optic sampling (EOS), which involves a delay stage 24, quarter-wave plate (QWP), Wollaston prism (WP), and balanced photodetectors (BPD) to retrieve the oscillating THz electric field. The delay stage varies the time delay between two NIR pulses for THz generation and detection. A germanium (Ge) wafer 26 may be placed in the THz beam path to act as a spectral filter, transmitting the THz and blocking the NIR light transmitted through the generation crystal. The THz beam path may be enclosed in a box 28 purged with dry air to remove absorption features due to atmospheric water vapor. The PFB may be located after a laser source 18 or fiber laser oscillator. The combination of these three modules uniquely provides the present system with a spectral bandwidth extending from 0.6 to 4.8 THz while keeping a high dynamic range exceeding 30 dB and peaking at 50 dB at 3.8 THz.

In one example embodiment, the laser source 18 is a NIR laser with a relatively long pulse duration (130 fs) and a relatively low power (200 mW). Such a laser is significantly cheaper than traditional THz system lasers which produce optical pulses with a temporal duration under 100 fs or deliver femtosecond pulses with a relatively high power output (>500 mW)

### Peak-Field Booster

In one aspect, a Peak-Field Booster (PFB) is a compact module to increase the spectral bandwidth of an ultrafast NIR source with a polarization-maintaining fiber (PMF) 20 and recompress the pulse to a time duration smaller than its initial value with a chirped mirror pair (CMP) 22. When this process is accomplished with minimum loss, the peak electric field of the optical pulse can be significantly increased. Such a modified NIR pulse is not only able to generate a broader THz spectrum due to its own broader spectral bandwidth, but its shorter pulse duration also enables a more efficient THz generation process and more efficient THz detection process for high THz frequencies.

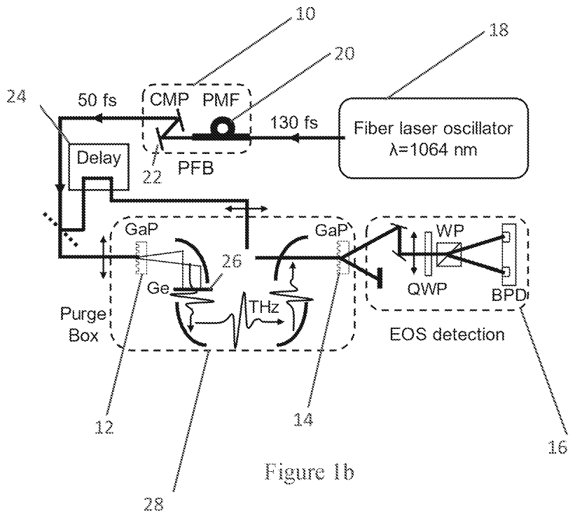

The PFB overcomes bandwidth limitations imposed by the ultrafast NIR laser via nonlinear propagation in an optical fiber to broaden the NIR spectrum, resulting in a broader THz spectrum, as shown in FIG. 2a. Moreover, the PFB compresses this broader NIR bandwidth to a shorter time duration, as shown in FIG. 2b, thus enhancing the peak field of the ultrafast source for more efficient THz generation. Shorter pulse duration also enhances detection efficiency of high THz frequencies, thus contributing to broadening the bandwidth of the entire system. FIGS. 2a and 2b show that addition of a PFB laser with the NIR laser broadens the spectrum to a ˜12 THz bandwidth (FWHM) and shortens the time duration from 130 fs to 50 fs.

### Grating-Assisted THz Generation

For traditional THz generation and detection, there is a trade-off between THz field and bandwidth due to phase-matching conditions. Focusing a broadband NIR pulse into a thick crystal will yield a strong THz pulse but will have a narrow bandwidth, while a thin crystal will result in a weak THz pulse with a broad bandwidth.

In one aspect of the present invention, there is provided an etched crystal in the generation process, following the PFB. An etched crystal is also provided in the detector. The crystals may be GaP and may have a grating. The use of a thick crystal enables broadband THz generation and detection. In this example, the PFB and etched GaP crystals work in unison to create one of the most broadband and sensitive compact THz-TDS systems available.

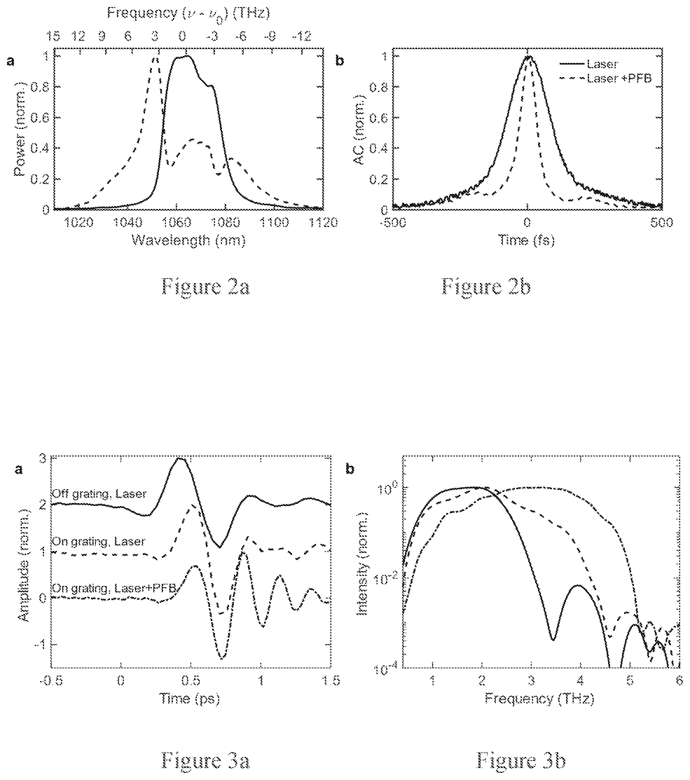

To demonstrate how the components of the present invention work together for broadband THz generation, the THz time-domain signal is measured using just the laser in flat and etched GaP crystals, and this result is compared to one obtained with the laser and PFB. FIG. 3a shows time-domain traces of a comparison of a generator having (1) a laser with a regular crystal with no grating, (2) a laser with a crystal having a grating, and (3) a laser with PFB and crystal having a grating. In this example, an etched GaP crystal having a thickness of 1 mm was used for THz generation, while a thin GaP crystal having a thickness of 2 mm was used for detection. FIG. 3b shows spectral intensities of the same comparisons as FIG. 3a. It can be seen that implementation of only an etched GaP crystal with only the ultrafast NIR source/laser extends the THz bandwidth from 2 THz to 3 THz, with the THz spectrum peaking at 2 THz in both cases. Adding the PFB to the system pushes the THz spectrum to even higher frequencies, extending the bandwidth to ˜4 THz and a peak THz frequency of 3.2 THz.

### Grating Assisted THz-Detection

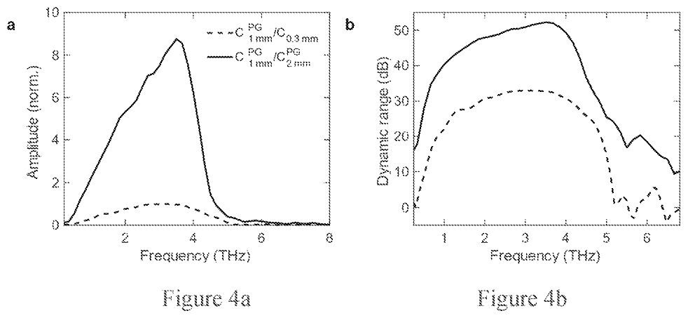

In a further example, a pair of periodically patterned GaP crystals is implemented for THz generation and detection and this result is compared to the spectrum recorded with a thin GaP crystal for detection. The spectral amplitude of each scenario is shown in FIG. 4a, while the dynamic range is shown in FIG. 4b. In this example, an etched GaP crystal is used for THz generation (C^{PG}_{1 mm}), and a 2 mm thick etched GaP crystal (C^{PG}_{2 mm}) is compared to a 0.3 mm thick GaP crystal (C_{0.3 mm}) for detection. FIG. 4b shows that the double grating configuration with the etched GaP on both generation and detection pushes the peak THz frequency to ˜3.5 THz and increases the dynamic range by ˜20 dB across the entire spectrum. The resulting spectral bandwidth and dynamic range (peak at >50 dB) is comparable to a THz-TDS system employing an amplified (and expensive) NIR source and flat, thin crystals for THz generation and detection as shown in W. Cui et al. Advanced Optical Materials 10, 2101136 (2022).

FIGS. 2 to 4 show that the combination of the peak field booster with the described elements increases the spectral bandwidth and efficiency for THz generation and detection processes in a THz-TDS system. The present invention is able to achieve a high dynamic range of >50 dB around 3.5 THz, which is very distinctive. Most importantly, the present configuration relies on a cost-effective NIR source allowing the full system to be built at a lower cost and sold at a competitive price.

It will be appreciated by one skilled in the art that variants can exist in the above-described arrangements and applications. For example, while the examples discussed herein used GaP crystals, etching a grating onto other nonlinear crystals such as GaSe or LiNbO3 would be possible. Other crystals could improve phase-matching conditions for high THz frequencies in thick crystals. In the example provided herein, the laser source is centered at a wavelength of 1064 nm; however, lasers centered at other wavelengths could work, provided that phase-matching can be achieved.

In the examples provided herein, the PFB consists of a fiber and a pair of chirped mirrors; however, one could broaden the spectrum in a different way. For example, by focusing the output laser beam into a highly nonlinear material, the spectrum could be broadened. Also, other dispersion compensation techniques, such as a prism pair or fiber Bragg gratings, could be used.

Following from the above description, it should be apparent to those of ordinary skill in the art that, while the methods and apparatuses herein described constitute exemplary embodiments of the present invention, the invention described herein is not limited to any precise embodiment and that changes may be made to such embodiments without departing from the scope of the invention as defined by the claims. Consequently, the scope of the claims should not be limited by the preferred embodiments set forth in the examples but should be given the broadest interpretation consistent with the description as a whole. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein. The amounts, sizes and examples discussed herein are for example purposes only and should not limit the scope of the claims or variants thereof which would be understood by a person of skill in the art.

1. A THz system comprising,
a generator having an optical source followed by a peak-field booster (PFB) unit and a first periodically patterned nonlinear crystal; and
a detector having a second periodically patterned nonlinear crystal.

2. The system of claim 1 wherein the optical source is an ultrafast NIR laser.

3. The system of claim 1 wherein the first periodically patterned nonlinear crystal is a GaP crystal.

4. The system of claim 3 wherein the second periodically patterned nonlinear crystal is a GaP crystal.

5. The system of claim 1 wherein the optical source is centered at a wavelength of 1064 nm.

6. The system of claim 1 wherein the PFB is a fiber and a pair of chirped mirrors.

7. The system of claim 1 wherein the PFB module is replaced by another module relying on a highly nonlinear material for spectral broadening

8. The system of claim 1 wherein the PFB module is replaced by another module relying on any dispersion compensation components including a prism pair or a fiber Bragg grating.

9. The system of claim 1 further comprising a purge box enclosing the first periodically patterned nonlinear crystal; and the second periodically patterned nonlinear crystal.

10. The system of claim 9 wherein the purge box further comprises a Germanium (Ge) wafer following the first periodically patterned nonlinear crystal.

11. The system of claim 1 wherein the detector comprises a delay stage, a quarter-wave plate (QWP), a Wollaston prism (WP), and balanced photodetectors (BPD).

12. The system of claim 1 wherein the second periodically patterned nonlinear crystal is a GaP crystal.
